(19) United States
(12) Patent Application Publication
(10) Pub. No.: US 2019/0095947 A1
(43) Pub. Date: Mar. 28, 2019

(54) TERMINAL DEVICE, DETERMINATION METHOD, AND RECORDING MEDIUM

(71) Applicant: FUJITSU LIMITED, Kawasaki-shi (JP)

(72) Inventors: Teruyuki Sato, Tama (JP); Koichiro Niinuma, Kawasaki (JP)

(73) Assignee: FUJITSU LIMITED, Kawasaki-shi (JP)

(21) Appl. No.: 16/137,615

(22) Filed: Sep. 21, 2018

(30) Foreign Application Priority Data
Sep. 28, 2017 (JP) 2017-187894

(51) Int. Cl. G06Q 30/02; G06F 3/0485

(52) U.S. Cl. CPC G06Q 30/0246; G06F 3/04883; G06F 3/0485

(57) ABSTRACT

A non-transitory computer-readable storage medium storing a program that causes a processor of a terminal device to execute a process, the process includes detecting at least one of information on an operational state of the terminal device and information on the orientation of the terminal device; and when predetermined information is displayed on a screen of the terminal device, calculating a change in careful watching of the screen by an operator who operates the terminal device, based on at least one of the information on the operational state of the terminal device and the information on the orientation of the terminal device.

### CROSS-REFERENCE TO RELATED APPLICATION

This application is based upon and claims the benefit of priority of the prior Japanese Patent Application No. 2017-187894, filed on Sep. 28, 2017, the entire contents of which are incorporated herein by reference.

### FIELD

The embodiments discussed herein are related to a terminal device, a determination method, and a recording medium.

### BACKGROUND

There are techniques for supporting customers in taking actual purchasing behaviors when the customers use mobile terminals such as smartphones and tablets to purchase what they want on an electronic commerce (EC) site.

In EC markets, it is important to promote potential customers to be actual purchasing customers. Marketing automation, which automates traditional sales activities such as DM sending and telephone calling to customers via manual operations, has become possible with the progress of technology. Contact points with customers are digitized like mails and web pages. In an EC site, how much the potential purchasing willingness of a person visiting a web page is brought out and linked to an actual purchasing behavior is becoming an important evaluation indicator, namely a key performance indicator (KPI).

In this way, there is a method of analyzing whether or not an unspecified number of users who reference a web page such as ac EC site are interested in a “location” on the web page. Whether a user who accessed the web page is interested in a “location” and conversely a “location” that causes the customer to leave the web page is valuable customer information.

In recent years, half of access to EC sites has been made by mobile terminals such as smartphones. If customer's psychology is detected via smartphones and appropriate information or support is provided, it is possible to promote purchasing on an EC site.

There is a method of distinguishing potential customers based on the psychology of how users felt about information presented on a web page.

For example, there is a technique for evaluating a user's response based on a physiological response of the user to a presented content and displaying a content and the evaluation result on a screen.

There is a technique for providing augmented information according to an area viewed by a user.

There is a technique for presenting a content created based on a subconscious mind model of a user and detecting a reaction of the user.

There is a technique for distributing a content in which a user is interested based on customer's psychology and distributing information indicating a detail of the content to the user who is interested in the content.

As related art, for example, International Publication Pamphlet No. WO2007/135796, Japanese Laid-open Patent Publication No. 2015-114798, Japanese Laid-open Patent Publication No. 2011-118558, Japanese Laid-open Patent Publication No. 2009-265703, and the like have been disclosed.

A degree of user's interest is measured during a certain unit time period or more in order to measure whether the user is interested in presented information. In the conventional techniques, however, a technique for detecting a user's reaction in real time is not disclosed. Under the aforementioned circumstances, it is desirable to detect a change in user's psychology for presented information.

### SUMMARY

According to an aspect of the invention, a non-transitory computer-readable storage medium storing a program that causes a processor of a terminal device to execute a process, the process includes detecting at least one of information on an operational state of the terminal device and information on the orientation of the terminal device; and when predetermined information is displayed on a screen of the terminal device, calculating a change in careful watching of the screen by an operator who operates the terminal device, based on at least one of the information on the operational state of the terminal device and the information on the orientation of the terminal device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a schematic configuration of a determination system according to a first embodiment;

FIG. 2 is a diagram illustrating a method for setting a weight coefficient based on a scrolling velocity;

FIG. 3 is a diagram illustrating an example in which users' behaviors are classified into two categories, a degree of interest and a careful watching state as a model indicating customer's psychology leading to a purchasing behavior;

FIG. 4 is a diagram illustrating an example of results of estimating psychology;

FIG. 5 is a block diagram illustrating a schematic configuration of a computer functioning as an information processing terminal according to the first embodiment;

FIG. 6 is a block diagram illustrating a schematic configuration of a computer functioning as a content server according to the first embodiment;

FIG. 7 is a flowchart illustrating an example of a determination process according to the first embodiment;

FIG. 8 is a block diagram illustrating a schematic configuration of a determination system according to a second embodiment;

FIG. 9 is a diagram illustrating an example of a method for setting weight coefficients based on the momentum of a terminal;

FIG. 10 is a block diagram illustrating a schematic configuration of a computer functioning as an information processing terminal according to the second embodiment;

FIGS. 11A and 11B are flowcharts illustrating an example of a determination process according to the second embodiment;

FIG. 12 is a block diagram illustrating a schematic configuration of a computer functioning as an information processing terminal according to a third embodiment;

FIG. 13 is a diagram illustrating a method for setting weight coefficients for a screen enlargement rate;

FIG. 14 is a block diagram illustrating a schematic configuration of a computer functioning as an information processing terminal according to the third embodiment; and

FIGS. 15A and 15B are flowcharts illustrating an example of a determination process according to the third embodiment.

### DESCRIPTION OF EMBODIMENTS

Techniques that are the premise of embodiments are described below.

There is a technique for providing information based on a degree of user's interest in a content of a web page. For example, there is a technique for recommending a content when a degree of interest is high. In this technique, based on a content and a browsing history of the content, the ratio of a time length for browsing the content with respect to each time period is defined as a degree of user's interest in the content to be estimated for each time period or a degree of user's interest in a category of the content. There is a technique for calculating a degree of user's interest in a content based on scrolling operation information without presenting and disclosing the content. If these techniques are used, it is technically possible to present related information when a degree of interest exceeds a certain threshold. There is a method for finely sectioning a document, calculating a browsing time length, and extracting a section of a content in which a user is interested.

In the conventional techniques, however, if the ratio of a time length for browsing a content with respect to each time period is considered, and a user takes the same behavior as a past history, related information is basically presented based on past analyzed results. Thus, it is not possible to make time resolution shorter than the length of a reproduced content and present information in real time. If a section of a content is extracted, it is not possible to determine whether or not a user is interested in the content presented within a small single screen of a smartphone.

It is difficult to detect a degree of interest that may be detected by a conventional technique, without scrolling and watching a certain amount of a content, and there is a problem that time resolution for detecting is low.

In order to take advantage of psychological information of a user who is referencing an EC site and present appropriate information, a system for detecting a high time-resolution user's response is to be provided.

Even if information is presented when a user is interested in a content, it is difficult to recognize various inside of the user's mind and initially present appropriate information. Typically, a coupon is issued at the stage of the presentation of information and there is a problem that a coupon is issued to customers who do not want the coupon and for which the coupon is not useful.

A service that supports what each user wants to do for web contents like actual shops is referred to as web customer service. For information presentation in a web customer service, it is considered that questioning starts with a phrase “what are you looking for?” and that the customer service is changed in response to a user's reaction.

Thus, the embodiments provide a method for detecting a process of a change in user's psychology or presenting information based on a degree of interest and detecting how the user feels about the presented information.

### First Embodiment

Hereinafter, an example of a first embodiment is described in detail with reference to drawings.

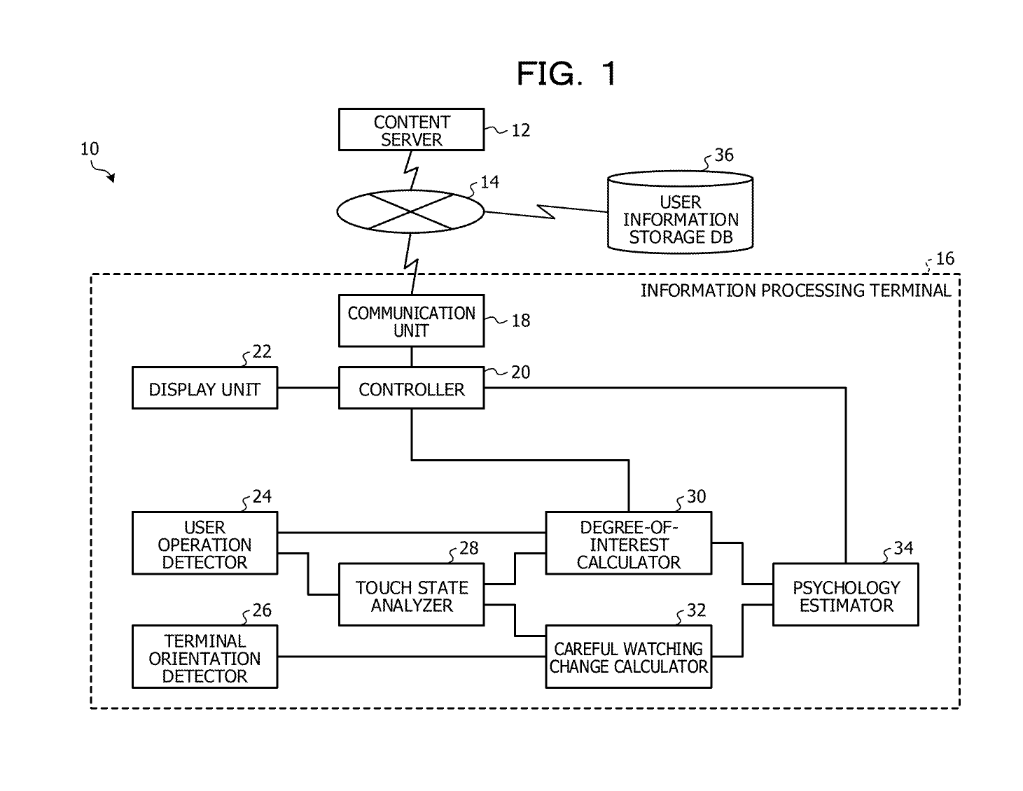

As illustrated in FIG. 1, a determination system 10 according to the first embodiment includes a content server 12, an information processing terminal 16, and a user information storage DB 36. The content server 12, the information processing terminal 16, and the user information storage DB 36 are connected to each other via a network 14 such as the Internet. The user information storage DB 36 is a database included in a user information managing server (not illustrated). The information processing terminal 16 is an example of a determining device.

The content server 12 transmits a content to the information processing terminal 16 in accordance with a content request signal from the information processing terminal 16. The content server 12 transmits a message to the information processing terminal 16 in accordance with a message request signal received from the information processing terminal 16 and corresponding to the content.

The information processing terminal 16 includes a communication unit 18, a controller 20, a display unit 22, a user operation detector 24, a terminal orientation detector 26, a touch state analyzer 28, a degree-of-interest calculator 30, a careful watching change calculator 32, and a psychology estimator 34. The degree-of-interest calculator 30 and the careful watching change calculator 32 are an example of a calculator. The psychology estimator 34 is an example of an estimator.

The communication unit 18 transmits and receives information to and from the content server 12. For example, the communication unit 18 receives a content transmitted from the content server 12. The communication unit 18 transmits, to the content server 12, a content request signal output by the controller 20 described later. The communication unit 18 periodically transmits results, received from the psychology estimator 34, of estimating psychology to the user information storage DB 36 and periodically causes the results of estimating the psychology to be recorded in the user information storage DB 36.

The controller 20 controls the display unit 22 described later to cause the display unit 22 to display a content received by the communication unit 18. The controller 20 controls the display unit 22 to cause the display unit 22 to present a message received by the communication unit 18.

The display unit 22 is achieved by a display such as a liquid crystal display (LCD) or an organic electroluminescence display (OELD), for example. A display screen of the display unit 22 is changed by an input operation such as touching by a user. The display unit 22 presents a content in accordance with control by the controller 20. The display unit 22 presents a message related to the content in accordance with control by the controller 20. It is sufficient if a content provided by the content server 12 is displayed by the display unit 22. The content provided by the content server 12 may be a content including a text such as a document or may be a content including an image. The message may include either or both of a text and an image, like the content.

During the time when a content is displayed in the information processing terminal 16, the user operation detector 24 receives an input operation by the user from a touch panel superimposed on the display unit 22, detects the input operation by the user, and detects whether an input operation has been performed. Specifically, the user operation detector 24 detects the types of user's input operations such as tapping, flicking, swiping, and pinching. The user operation detector 24 detects an operation of scrolling the screen from the types of the input operations. Then, the user operation detector 24 measures an operation time length within a unit time period. The operation time length includes a scrolling operation time length for performing the scrolling operation. The user operation detector 24 measures a nonoperation time length during which an operation is not performed and that is included in the unit time period. Thus, the user operation detector 24 detects operation information including the types of the input operations, time when the input operations have been performed, contact positions, an operation time length within each unit time period, and a nonoperation time period within each unit time length. Each of the types of the input operations is an example of an operational state of the information processing terminal 16.

The terminal orientation detector 26 detects a change in the orientation of the information processing terminal 16 for each unit time period. As the terminal orientation detector 26, a 9-axis sensor is used, for example. Gravity acceleration, an azimuth compass, and gyro data as inertial force are used by the terminal orientation detector 26. The change in the orientation is an example of information on the orientation of the terminal.

The touch state analyzer 28 detects whether or not the touch panel is being touched. In addition, the touch state analyzer 28 detects the operational state based on the types of touch operations. The types of the touch operations are zooming, scrolling, and the like. The touch state analyzer 28 detects the operational state based on the operations or detects a scrolling velocity, for example. Specifically, regarding the scrolling velocity, the touch state analyzer 28 detects the amount (pixels) of screen scrolling input by the user from the touch panel superimposed on the display unit 22. Then, the touch state analyzer 28 divides the amount of the scrolling by a time period (seconds) for the scrolling detected by the user operation detector 24, thereby calculating the scrolling velocity (pixels/s) per unit of time. The amount of the scrolling is an example of information on a change in the screen.

The degree-of-interest calculator 30 calculates a degree of user's interest in a content for each unit time period based on a time length of a scrolling operation in a user operation detected by the user operation detector 24 and a scrolling velocity calculated by the touch state analyzer 28. The degree of interest is calculated according to the following Equation (1), for example.

$$I ( t ) = Σ \frac{a time period for a scrolling operation}{a scrolling velocity weight coefficient {w}_{scr}} + Σ a nonoperation time period \qquad Equation ( 1 )$$

It is considered to be desirable to use a quantification method based on a time axis to calculate a degree of interest without depending on a content, instead of a method for sectioning a content into segments and performing measurement.

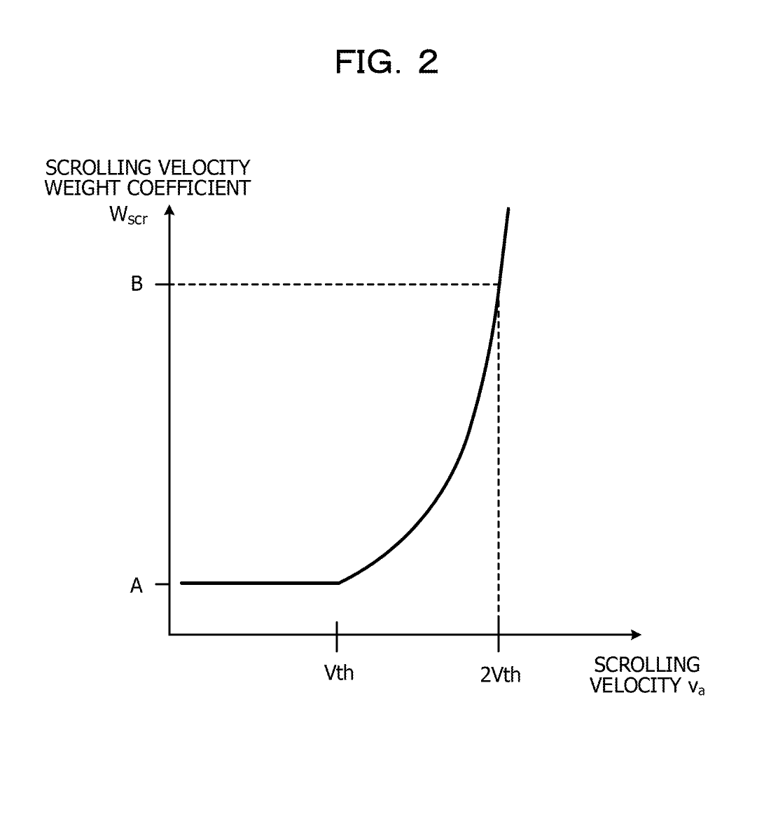

A degree I(t) of interest in a content is calculated for each of unit time periods (of 1 second as an example) according to Equation (1). FIG. 2 illustrates an example of a method for setting the scrolling velocity weight coefficient w_{scr} of Equation (1) for each of the unit time periods. As illustrated in FIG. 2, the scrolling velocity weight coefficient w_{scr} may be set in advance so that the scrolling velocity weight coefficient w_{scr} is a fixed value in a state in which a scrolling velocitylarger vₐ is equal to orthan 0 and equal to or smaller than a threshold vₜₕ and that as the scrolling velocity vₐ is larger, the scrolling velocity weight coefficient w_{scr} is larger in a state in which the scrolling velocity vₐ is larger than the vₜₕ. In the example illustrated in FIG. 2, if the scrolling threshold velocity vₐ is continuously equal to or smaller than the threshold vₜₕ during a unit time period (of 1 second), the degree of interest is increased by 1 point. On the other hand, if the scrolling velocity vₐ exceeds the threshold vₜₕ, the scrolling velocity weight coefficient w_{scr} rapidly increases and the degree of interest is calculated to be a value lower than 1. Thus, in Equation (1), when the scrolling velocity vₐ increases, the scrolling velocity weight coefficient w_{scr} increases and, as a result, the degree of interest during the scrolling operation is evaluated as a low value. In the case where the scrolling operation is stopped, as a reading time length is shorter, the degree of interest is evaluated as a lower value. Specifically, if the user skips reading a content, a degree of interest in the content is evaluated as a low value. If the user scrolls a content at a scrolling velocity that enables movements of eyeballs to be traced or if the user stops scrolling and watches the content, a degree of interest in the content is evaluated as a high value.

The degree-of-interest calculator 30 determines whether or not a degree of interest exceeds a predetermined threshold for each of certain time periods (of, for example, 30 seconds).

The careful watching change calculator 32 calculates, for each of the unit time periods, a change in careful watching of the screen of the display unit 22 by the user who operates the information processing terminal 16, based on a scrolling amount detected by the touch state analyzer 28 and a change, calculated by the terminal orientation detector 26, in the orientation of the information processing terminal 16. The change in the careful watching is calculated after a message related to a content is presented by the display unit 22.

The principle of the change in the careful watching is the premise of a process by the careful watching change calculator 32 and is described below.

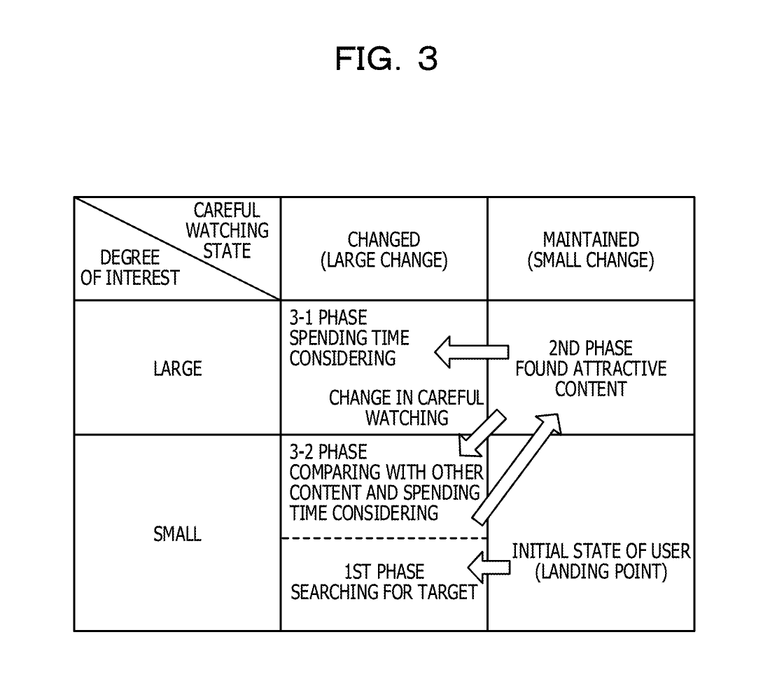

First, a model indicating customer's psychology leading to a purchasing behavior is described below. The model indicating the customer's psychology commonly indicates that attention is paid first and interest is developed next. As illustrated in FIG. 3, when the model indicating the customer's psychology is considered using an EC site, user's behaviors may be classified into two categories, a degree of interest and a careful watching state, which are indicated by orthants. FIG. 3 illustrates a 2×2 matrix in which an ordinate indicates the magnitude of the degree of interest and an abscissa indicates the magnitude of a change in the careful watching state. In the matrix, a customer journey indicating the user's behaviors, and changes in the user's psychology are organized. An orthant located on the lower right side of FIG. 3 is treated as a user's landing point. In the landing point, the degree of interest is small and a change in the careful watching state is small in a state before the careful watching state largely changes. Next, the state of the user changes to an orthant located on the lower left side of FIG. 3 (1st phase). In a state corresponding to the orthant located on the lower left side, the user looks for an attractive content, performs a search within a page while being not interested in any content, and searches for a target content. At this time, a change in the careful watching state is large. Then, the state of the user changes to an orthant located on the upper right side of FIG. 3 (2nd phase). In a state corresponding to the orthant located on the upper right side, the user has found an attractive content and maintains the careful watching state in order to carefully read a portion in the content.

As described above as a problem with the conventional techniques, time resolution for the detection of a degree of interest is not high and it is not possible to detect a change in user's psychology in real time. In other words, it is not possible to recognize inside of the user's mind or recognize why the user is interested in a content. For example, in an actual shop, a shop clerk asks a customer and tells “are you looking for a product like XX?” or the like while assuming that the user has yet to identify a product. In a web site, it is difficult to initially present information matching user's preference. A positive reason why a clerk tells “what are you looking for?” in an actual shop is that the clerk supports a customer via a conversation, searches inside mind of the customer, and guides the customer. In a web site, computerizing a conversation and improving the efficiency of the conversation is one of purposes for providing a web service. An interface that forces a customer to make an oral response even if voice is provided to the customer in a technical manner may not be desirable. Thus, for the web site, a method for presenting additional information via a pop-up window is considered.

It is not clear whether or not presented information is information that the user wants upon the presentation of the information. As reactions of the customer to the presentation of the information, the following three states are considered, (1) a state in which the presented information is appropriate and accepted by the customer (purchasing), (2) a state in which the user spends time considering whether to buy (spending time considering whether to buy, a 3-1 phase illustrated in FIGS. 3), and (3) a state in which the customer references another location in a web site and makes a comparison (making a comparison with another product and spending time considering whether to buy, a 3-2 phase illustrated in FIG. 3).

Except for the aforementioned three states, there is a case where the customer leaves the web site. This case is not explained and is omitted. The three states may not be distinguished by only the magnitude of a degree of interest. If a small message like a pop-up window is used, a reaction in an amount sufficient to calculate a degree of interest may not be obtained from the user in many cases. Especially, a reaction in a sufficient amount on a screen of a smartphone may not be obtained from the user, since the screen is small.

In the first embodiment, a method for detecting a user's reaction to presented information and supporting the presentation of the next information is used. In the first embodiment, as a criterion for detecting a user's reaction, a change in careful watching of the screen by the user or a high time constant criterion is introduced and it is determined that the state of the user is any of the three states.

Maintaining a careful watching state indicates a state (1) in which first information is appropriate and the user accepts and reads the first information. For example, looking away from the screen or quickly scrolling the screen and changing a page to another page may be detected as a change in careful watching. Based on a change in the careful watching, it is possible to distinguish between the states (1) and (2) or (3). It is possible to distinguish between the states (2) and (3). This is due to the fact that, if the user still watches the original page, the degree of interest is high, and if the user leaves the original page, the degree of interest is reduced. Thus, in the second presentation of information, the user's psychology is narrowed down and additional information is presented based on the state of the user.

The principle of the change in the careful watching is described above.

Based on the aforementioned principle, the careful watching change calculator 32 calculates a change in careful watching within a unit time period based on the weighted linear sum for first and second change amounts. The linear weights are calculated based on whether or not an operation is performed on the information processing terminal 16. The first change amount is the amount of a change in the careful watching and is calculated based on a change, calculated by the terminal orientation detector 26, in the orientation of the information processing terminal 16. The second change amount is the amount of a change in the careful watching and is calculated based on a scrolling amount detected by the touch state analyzer 28 and serving as the operational state of the information processing terminal 16. As the amount of an operation performed on the information processing terminal 16 is larger, the weight for the second change amount is larger. The following Equation (2) is obtained by formulating a change in the careful watching.

A change in careful watching=α×the frequency of a change in the screen+(1−α)×a change in the orientation of the terminal Equation (2)

α is a weight coefficient defined based on a time length for an operation performed on the information processing terminal 16 within a unit time period. α is a value equal to or larger 0 and equal to or smaller than 1. As the time length for the operation performed on the information processing terminal 16 within the unit time length is longer, the value of α is larger. On the other hand, as the time length for the operation performed on the information processing terminal 16 within the unit time period is shorter, the value of α is smaller. The frequency of the change in the screen corresponds to the calculated scrolling amount. The frequency of the change in the screen is not limited to the scrolling amount and may correspond to a change in a position within a web page due to a scrolling operation or may correspond to a change to be made in association with an operation.

The unit time period is, for example, 1 second or the like. It is assumed that the unit time period may be a timelength for a scrolling operation that causes the screen to quickly change. A change in the orientation of the information processing terminal 16 during the time when an operation is not performed may be detected within a short time period. Thus, the time resolution of the change, to be calculated according to Equation (2), in the careful watching is high. Whether or not a message presented as the first information is suitable to the user is not determined based on only the change, calculated according to Equation (2), in the careful watching. However, immediately after the presentation of the first information, a reaction to additional information on a content in which the user is temporarily interested may be detected from a change in the careful watching. In the first embodiment, a state immediately after the presentation of the first information is paid attention and a potential customer is determined. If the presentation of the first information is not appropriate, an operation of changing the screen is performed. If the presentation of the first information is appropriate and the user spends time considering whether to buy, the user may not concentrate on the screen, may not determine whether to buy, and may not carefully watch the screen, and the orientation of the information processing terminal 16 may be changed. Equation (2) uses the weighted linear sum to express a change in the careful watching based on the aforementioned two cases.

If a degree of interest that is calculated by the degree-of-interest calculator 30 is equal to or larger than a predetermined threshold, the psychology estimator 34 controls the controller 20 so that a message related to a content is presented by the display unit 22. The presentation of the message related to the content is an example of the presentation of the first information.

If the change, calculated by the careful watching change calculator 32, in the careful watching is equal to or larger than a predetermined threshold, the psychology estimator 34 causes the controller 20 to control the degree-of-interest calculator 30 so that the degree-of-interest calculator 30 recalculates the degree of interest after the start of the calculation of the change in the careful watching. Then, the psychology estimator 34 controls the controller 20 so that a message defined based on the recalculated degree of interest is presented by the display unit 22. The presentation of the defined message is an example of the presentation of second information. As a typical example of the message to be presented, if the degree of interest is equal to or larger than a threshold, a coupon indicating “10, 000 yen discount now only” is issued, and if the degree of interest is smaller than the threshold, information that enables the user to make a comparison and consider a product and indicates that “there are various types of this product” or the like is presented.

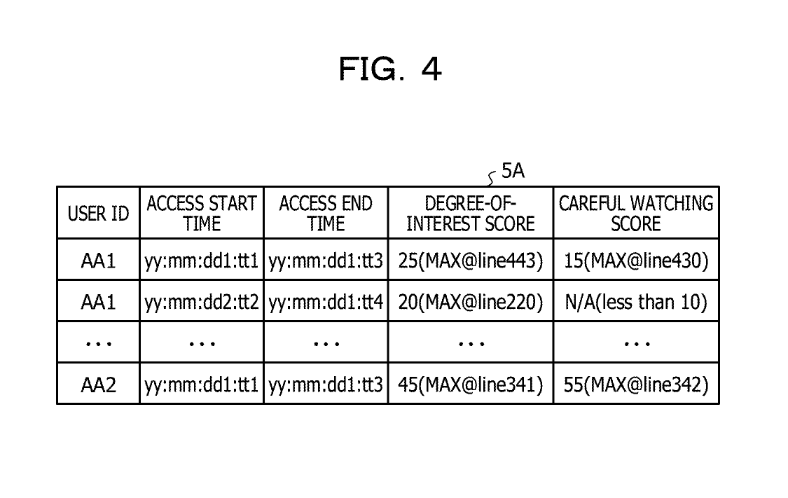

The psychology estimator 34 records the degree, calculated by the degree-of-interest calculator 30, of interest and the change, calculated by the careful watching change calculator 32, in the careful watching in the user information storage DB 36 via the communication unit 18 as the results of estimating the psychology of the user who operates the information processing terminal 16. FIG. 4 illustrates an example of results 5A of estimating the psychology. The results 5A of estimating the psychology are a table including user IDs, access start time, access end time, degree-of-interest scores, and careful watching scores. For example, a user having a user ID “AA1” has a degree-of-interest score 25 (MAX@line 443) and a careful watching score 15 (MAX@line 430) for access made during a time period from “yy:mm:dd1:tt1” to “yy:mm:dd1:tt3”. MAX@lineXXX added after the scores indicates the positions (row numbers) of contents for which the maximum values of the scores have been calculated. The user IDs are IDs associated with information processing terminals 16. The degree-of-interest scores transmitted by the multiple information processing terminals 16 and the careful watching scores transmitted by the multiple information processing terminals 16 are recorded. The careful watching scores are an example of results related to a change in careful watching.

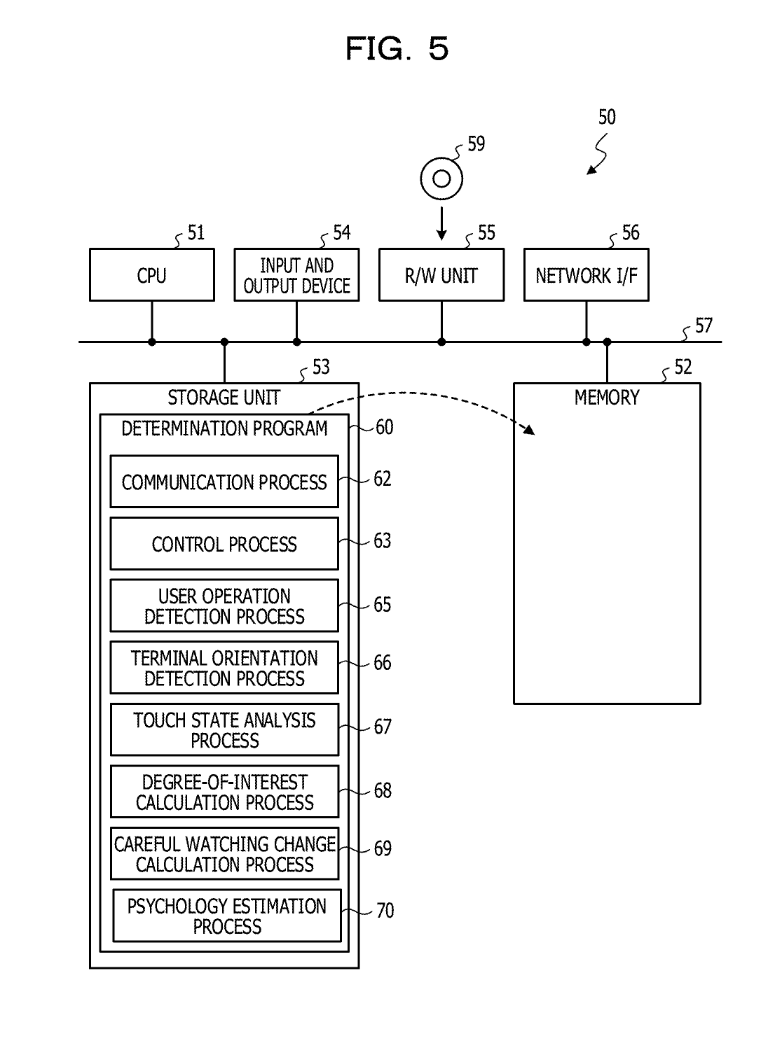

The information processing terminal 16 may be achieved by a computer 50 illustrated in FIG. 5, for example. The computer 50 includes a CPU 51, a memory 52 serving as a temporal storage region, and a nonvolatile storage unit 53. The computer 50 also includes an input and output device 54 serving as the display unit 22, the touch panel superimposed on the display unit 22, and the like, and a reading and writing (R/W) unit 55 that controls reading and writing of data from and to a recording medium 59. The computer 50 also includes a network interface (I/F) 56 that is connected to a network such as the Internet. The CPU 51, the memory 52, the storage unit 53, the input and output device 54, the R/W unit 55, and the network I/F 56 are connected to each other via a bus 57.

The storage unit 53 may be achieved by a hard disk drive (HDD), a solid state drive (SSD), a flash memory, or the like. In the storage unit 53 serving as a storage medium, a determination program 60 that causes the computer 50 to function as the information processing terminal 16 is stored. The determination program 60 includes a communication process 62, a control process 63, a user operation detection process 65, a terminal orientation detection process 66, a touch state analysis process 67, a degree-of-interest calculation process 68, a careful watching change calculation process 69, and a psychology estimation process 70.

The CPU 51 reads the determination program 60 from the storage unit 53, loads the read determination program 60 into the memory 52, and sequentially executes the processes included in the determination program 60. The CPU 51 executes the communication process 62, thereby operating as the communication unit 18 illustrated in FIG. 1. The CPU 51 executes the control process 63, thereby operating as the controller 20 illustrated in FIG. 1. The CPU 51 executes the user operation detection process 65, thereby operating as the user operation detector 24 illustrated in FIG. 1. The CPU 51 executes the terminal orientation detection process 66, thereby operating as the terminal orientation detector 26 illustrated in FIG. 1. The CPU 51 executes the touch state analysis process 67, thereby operating as the touch state analyzer 28 illustrated in FIG. 1. The CPU 51 executes the degree-of-interest calculation process 68, thereby operating as the degree-of-interest calculator 30 illustrated in FIG. 1. The CPU 51 executes the careful watching change calculation process 69, thereby operating as the careful watching change calculator 32 illustrated in FIG. 1. The CPU 51 executes the psychology estimation process 70, thereby operating as the psychology estimator 34 illustrated in FIG. 1. Thus, the computer 50 executes the determination program 60, thereby functioning as the information processing terminal 16. The CPU 51 that executes the program is hardware.

The functions achieved by the determination program 60 may be achieved by a semiconductor integrated circuit, more specifically, an application specific integrated circuit (ASIC) or the like, for example.

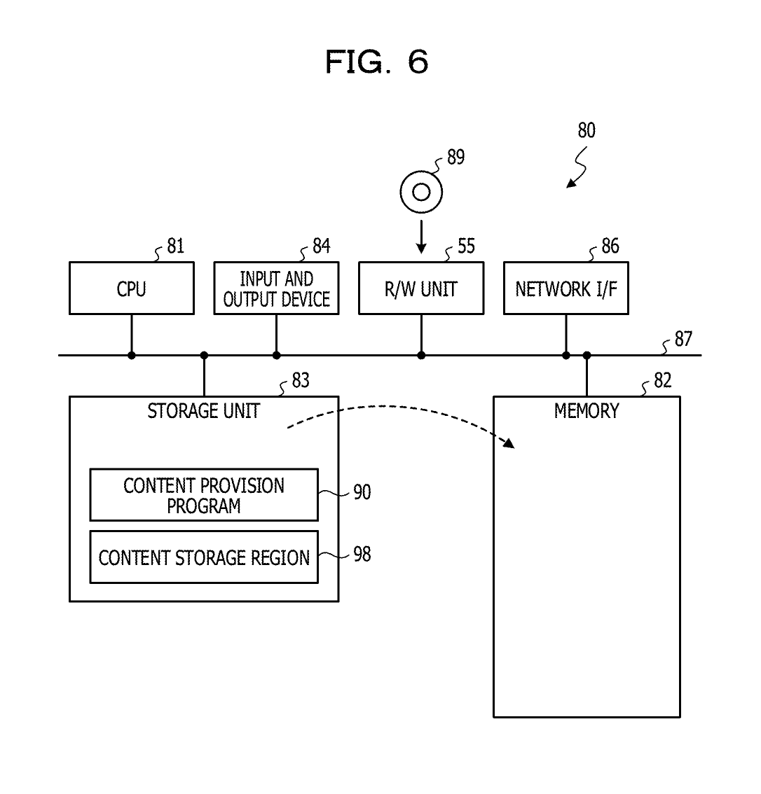

The content server 12 may be achieved by a computer 80 illustrated in FIG. 6, for example. The computer 80 includes a CPU 81, a memory 82 serving as a temporal storage region, and a nonvolatile storage unit 83. The computer 80 also includes an input and output device 84 serving as a display device and an input device, and an R/W unit 85 that controls reading and writing of data from and to a recording medium 89. The computer 80 also includes a network I/F 86 that is connected to a network such as the Internet. The CPU 81, the memory 82, the storage unit 83, the input and output device 84, the R/W unit 85, and the network I/F 86 are connected to each other via a bus 87.

The storage unit 83 may be achieved by an HDD, an SSD, a flash memory, or the like. In the storage unit 83 serving as a storage medium, a content provision program 90 that causes the computer 80 to function as the content server 12 is stored. In a content storage region 98, contents that may be provided to the information processing terminal 16 are stored in advance.

The functions achieved by the content provision program 90 may be achieved by a semiconductor integrated circuit, more specifically, an ASIC or the like, for example.

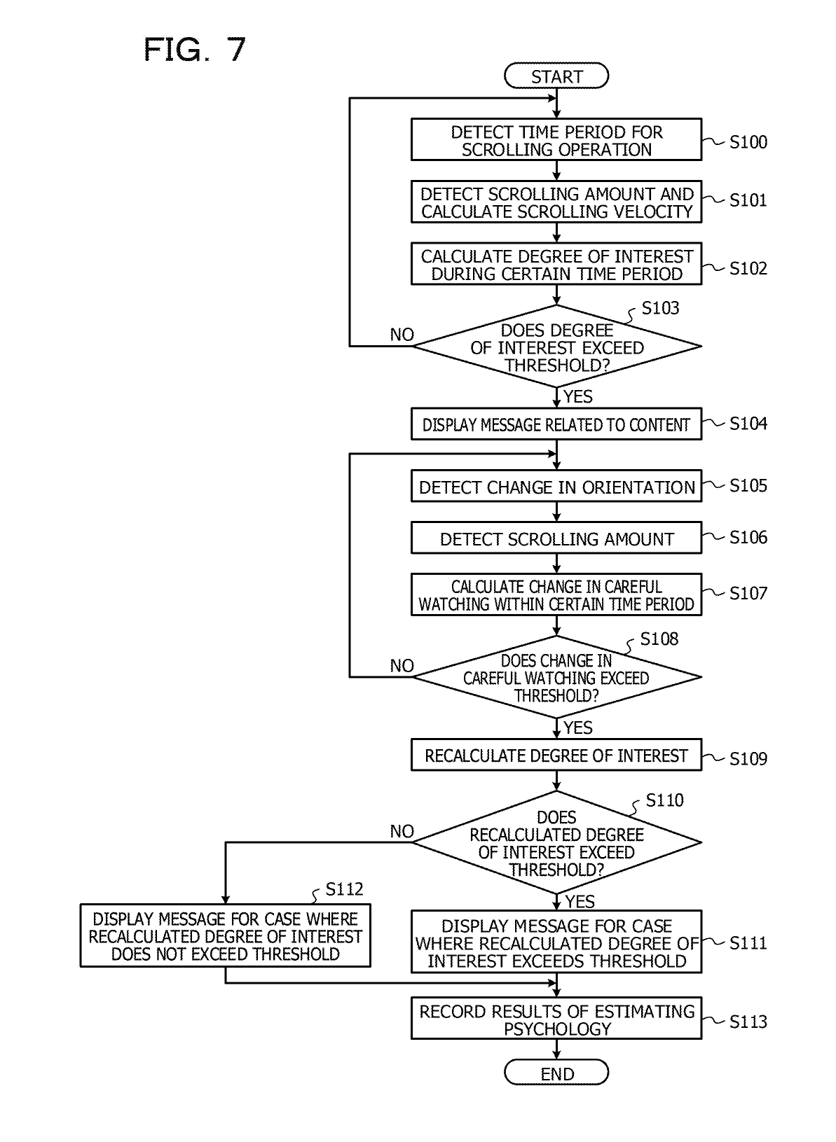

Next, effects of the determination system 10 according to the first embodiment are described. In the determination system 10, the information processing terminal 16 receives a content from the content server 12. Then, the received content is displayed by the display unit 22 of the information processing terminal 16. When the user operation detector 24 receives an operation input by the user, a determination process illustrated in FIG. 7 is executed in the information processing terminal 16. Processes are described below.

In step S100, the user operation detector 24 detects a time length for a scrolling operation by the user and a nonoperation time length for each of unit time periods included in a certain time period (of 30 seconds in this example).

In step S101, the touch state analyzer 28 detects the amount of the scrolling input by the user on the screen from the touch panel superimposed on the display unit 22 for each of the unit time periods included in the certain time period (of 30 seconds), based on the time period, detected in the aforementioned step S100, for the scrolling operation. Then, the touch state analyzer 28 calculates a scrolling velocity (pixels/s) by dividing the detected scrolling amount by the time length for the scrolling operation.

In step S102, the degree-of-interest calculator 30 calculates a degree of interest for each of the unit time periods included in the certain time period (of 30 seconds). The degree of interest for each of the unit time periods is calculated according to the aforementioned Equation (1) based on the time period, detected in step S100, for the scrolling operation, the nonoperation time length detected in step S100, and the scrolling velocity calculated in step S101.

In step S103, the degree-of-interest calculator 30 determines whether or not the degree of interest that has been calculated in step S102 during the certain time period exceeds a predetermined threshold. If the degree of interest exceeds the threshold, the process proceeds to step S104. If the degree of interest does not exceed the threshold, the process returns to step S100 to repeat the process of calculating a degree of interest during a certain time period.

In step S104, the psychology estimator 34 controls the controller 20 so that a message related to the content is presented by the display unit 22.

In step S105, the terminal orientation detector 26 detects a change in the orientation of the information processing terminal 16 for each of unit time periods included in a certain time period (of 5 seconds in this example).

In step S106, the touch state analyzer 28 detects a time length for a scrolling operation for each of the unit time periods included in the certain time period (of 5 seconds) in a similar manner to the aforementioned step S100. Then, the touch state analyzer 28 detects the amount of the scrolling input by the user on the screen from the touch panel superimposed on the display unit 22, based on the detected time length for the scrolling operation in a similar manner to the aforementioned step S101.

In step S107, the careful watching change calculator 32 calculates a change in careful watching for each of the unit time periods included in the certain time period (of 5 seconds), based on the weighted linear sum of the for the change, detected in step S105, in the orientation and the amount, detected in step S106, of the scrolling.

In step S108, the careful watching change calculator 32 determines whether or not the change, calculated in step S107, in the careful watching during the certain time period exceeds a predetermined threshold. If the change in the careful watching exceeds the threshold, the process proceeds to step S109. If the change in the careful watching does not exceed the threshold, the process returns to step S105 to repeats the process of calculating a change in the careful watching during a certain time period.

In step S109, the psychology estimator 34 causes the controller 20 to control the degree-of-interest calculator 30 so that the degree-of-interest calculator 30 recalculates the degree of interest after the start of the calculation of the change in the careful watching. The degree-of-interest calculator 30 recalculates the degree of interest in a similar manner to step S102.

In step S110, whether or not the recalculated degree of interest exceeds a predetermined threshold is determined. If the recalculated degree of interest exceeds the threshold, the process proceeds to step S111. If the recalculated degree of interest does not exceed the threshold, the process proceeds to step S112.

In step S111, the psychology estimator 34 controls the controller 20 so that a message for the case where the recalculated degree of interest exceeds the threshold is presented by the display unit 22.

In step S112, the psychology estimator 34 controls the controller 20 so that a message for the case where the recalculated degree of interest does not exceed the threshold is presented by the display unit 22.

In step S113, the degree of interest that has been calculated by the degree-of-interest calculator 30 and the change, calculated by the careful watching change calculator 32, in the careful watching are recorded in the user information storage DB 36 via the communication unit 18 as results of estimating the psychology of the user who operates the information processing terminal 16.

As described above, in the determination system according to the first embodiment, when the information processing terminal receives an input operation during the time when a content is displayed in the information processing terminal, the information processing terminal detects the operational state including the velocity of a scrolling operation. Then, the information processing terminal calculates a degree of interest based on the detected operational state. If the calculated degree of interest exceeds the threshold, the information processing terminal presents a message related to the content. After the presentation of the message, the information processing terminal calculates a change in careful watching of the screen based on the amount of the scrolling and a change in the orientation. Thus, the information processing terminal may detect a change in the psychology of the user for presented information.

### Second Embodiment

Next, a second embodiment is described. Sections that are the same as those described in the first embodiment are indicated by the same reference symbols as those described in the first embodiment, and a description thereof is omitted.

The second embodiment is different from the first embodiment in that the momentum of an information processing terminal is used for the calculation of a degree of interest.

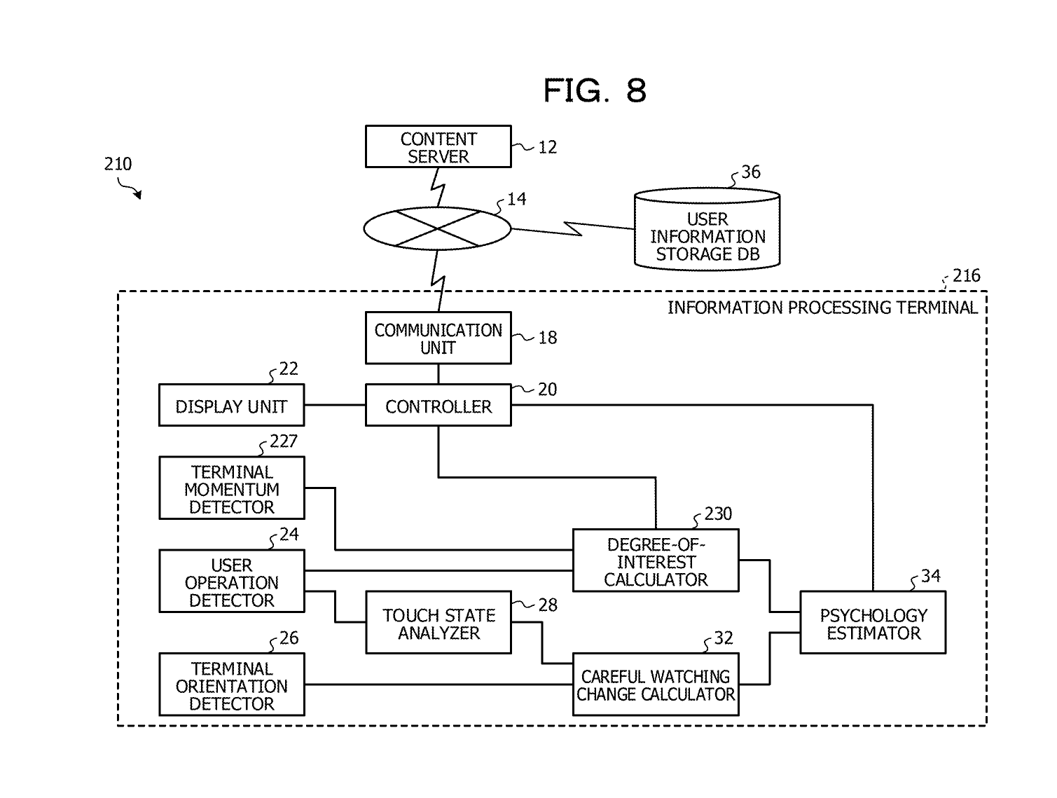

A determination system 210 according to the second embodiment is illustrated in FIG. 8 and includes the content server 12, an information processing terminal 216, and the user information storage DB 36. The content server 12, the information processing terminal 216, and the user information storage DB 36 are connected to each other via the network 14 such as the Internet.

The information processing terminal 216 includes the communication unit 18, the controller 20, the display unit 22, the user operation detector 24, the terminal orientation detector 26, a terminal momentum detector 227, a degree-of-interest calculator 230, the careful watching change calculator 32, and the psychology estimator 34.

The terminal momentum detector 227 detects the momentum of the information processing terminal 216 for each of unit time periods. The momentum of the information processing terminal 216 is an example of an operational state of the information processing terminal 216. The second embodiment describes the case where the terminal momentum detector 227 is achieved by a 9-axis sensor. The 9-axis sensor is composed of three types of sensors, a 3-axis gyroscope, a 3-axis accelerometer, and a 3-axis magnetometer. The terminal momentum detector 227, however, may be achieved by one or more of the three types of sensors. It is assumed that each of the unit time periods is a predetermined detection cycle T (T=1 second as an example).

The degree-of-interest calculator 230 calculates a degree of user's interest in a content for each of the unit time periods based on a time length for a scrolling operation in a user operation detected by the user operation detector 24, a nonoperation time length, and a time length for a movement, detected by the terminal momentum detector 227, of the information processing terminal 216. The degree of interest is calculated according to the following Equation (3), for example.

$$I ( t ) = Σ \frac{an operation time period}{a terminal momentum weight coefficient {w}_{d}} + Σ \frac{a nonoperation time period}{a terminal momentum weight coefficient {w}_{nop}} \qquad Equation ( 3 )$$

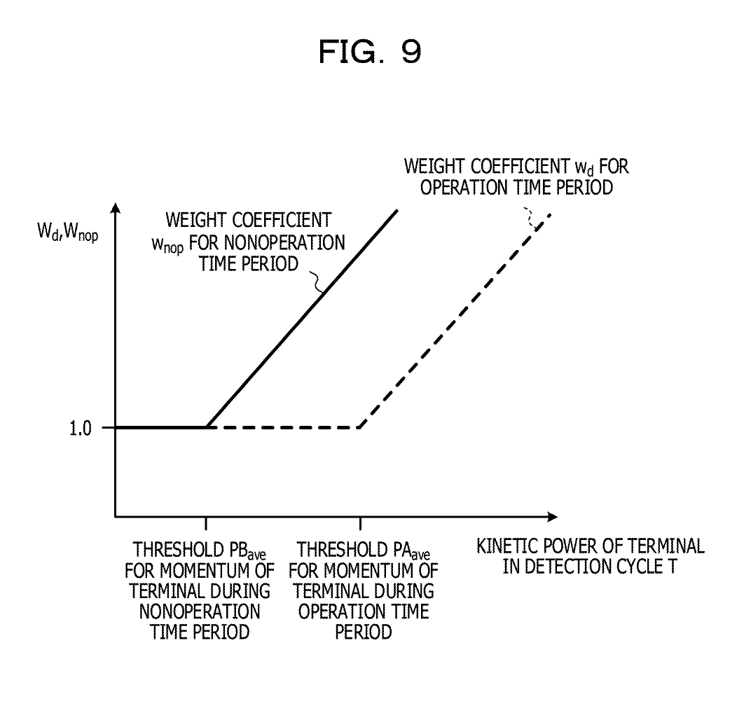

In the second embodiment, a degree I(t) of interest in a content is calculated for each of the unit time periods (of 1 second as an example). In the aforementioned Equation (3), the “operation time length ” is an operation time length within each unit time period, and the “nonoperation time length” is a nonoperation time length within each unit time period. As weight coefficients for the momentum of the terminal, the terminal momentum weight coefficient w_{d} during an operation time and the terminal momentum weight coefficient wₙₒₚ during an nonoperation time are set. For example, as illustrated in FIG. 9, the terminal momentum weight coefficient w_{d} during an operation time is calculated from the kinetic power of the information processing terminal during an operation time within a unit time period and a threshold PAₐᵥₑ for the momentum during the operation time . As illustrated in FIG. 9, the terminal momentum weight coefficient wₙₒₚ during a nonoperation time is calculated from the kinetic power of the information processing terminal during a nonoperation time within a unit time period and a threshold PBₐᵥₑ for the momentum during the nonoperation time

According to the aforementioned Equation (3) and the weight coefficient w_{d} illustrated in FIG. 9, if the kinetic power of the information processing terminal during the operation time is equal to or smaller than the threshold PAₐᵥₑ, the weight coefficient w_{d}=1.0, and the operation time length is added to the evaluation value I(t) of the degree of interest. Thus, if it is estimated that the kinetic power of the information processing terminal during the operation time is small and that the degree of user's interest in a content is high, the evaluation value I(t) of the degree of interest is high.

If the kinetic power of the information processing terminal during the operation time exceeds the threshold PAₐᵥₑ, as the kinetic power is larger, the value of the weight coefficient w_{d} is larger. Thus, an effect of the operation time length on the evaluation value I(t) of the degree of interest is small. Thus, if it is estimated that the kinetic power of the information processing terminal during the operation time is large and that the user does not concentrate on the browsing of a content, the evaluation value I(t) of the degree of interest is low.

According to the aforementioned Equation (3) and the weight coefficient wₙₒₚ illustrated in FIG. 9, if the kinetic power of the information processing terminal during the nonoperation time is equal to or smaller than the threshold PBₐᵥₑ, the weight coefficient wₙₒₚ=1.0 and the nonoperation time length is added to the evaluation value I(t) of the degree of interest. Thus, if it is estimated that the kinetic power of the information processing terminal during the nonoperation time is small and that the degree of user's interest in a content is high, the evaluation value I(t) of the degree of interest is high.

If the kinetic power of the information processing terminal during the nonoperation time exceeds the threshold PBₐᵥₑ, as the kinetic power is larger, the value of the weight coefficient wₙₒₚ is larger. Thus, an effect of the nonoperation time length on the evaluation value I(t) of the degree of interest is small. Thus, if it is estimated that the kinetic power of the information processing terminal during the nonoperation time is large and that the user does not concentrate on the browsing of a content, the evaluation value I(t) of the degree of interest is low.

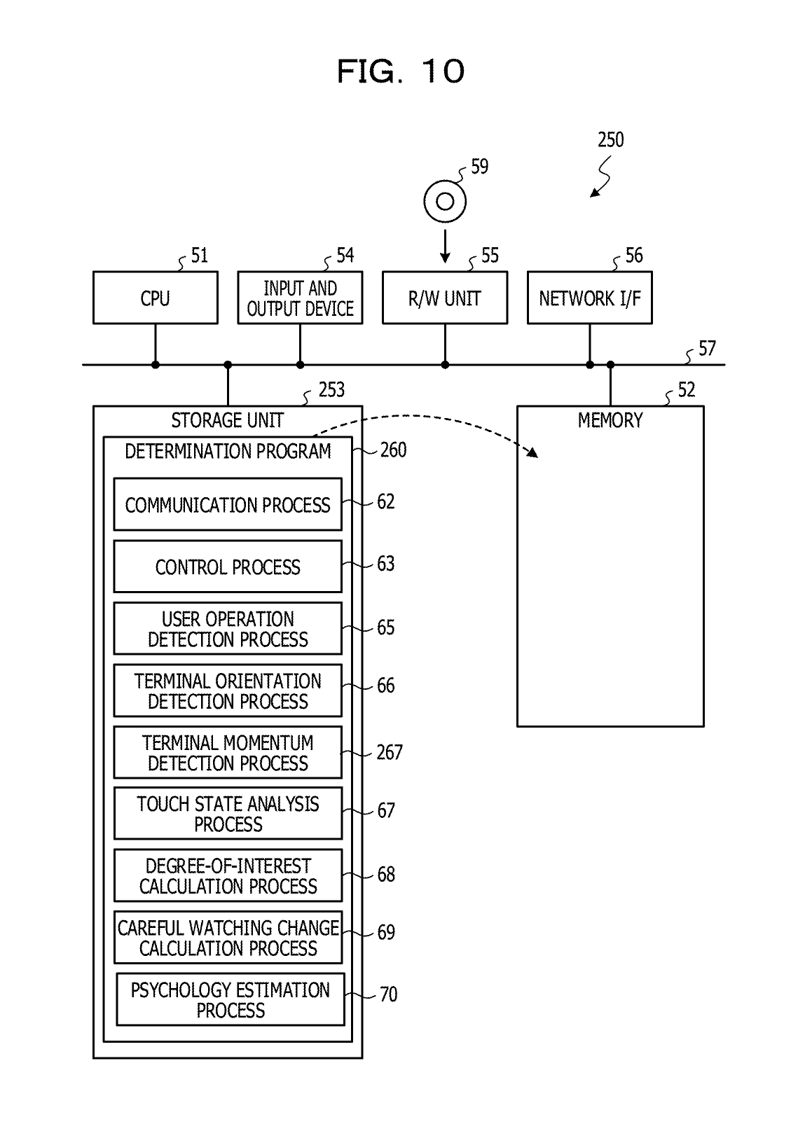

The information processing terminal 216 may be achieved by a computer 250 illustrated in FIG. 10, for example. The computer 250 includes the CPU 51, the memory 52 serving as the temporal storage region, and a nonvolatile storage unit 253. The computer 250 also includes the input and output device 54 serving as the display unit 22, the touch panel superimposed on the display unit 22, and the like, and the (R/W) unit 55 that controls reading and writing of data from and to the recording medium 59. The computer 250 also includes the network I/F 56 that is connected to a network such as the Internet. The CPU 51, the memory 52, the storage unit 253, the input and output device 54, the R/W unit 55, and the network I/F 56 are connected to each other via the bus 57.

The storage unit 253 may be achieved by an HDD, an SSD, a flash memory, or the like. In the storage unit 253 serving as a storage medium, a determination program 260 that causes the computer 250 to function as the information processing terminal 216 is stored. The determination program 260 includes the communication process 62, the control process 63, the user operation detection process 65, the terminal orientation detection process 66, and a terminal momentum detection process 267. The determination program 260 also includes the touch state analysis process 67, the degree-of-interest calculation process 68, the careful watching change calculation process 69, and the psychology estimation process 70.

The CPU 51 reads the determination program 260 from the storage unit 253, loads the read determination program 260 into the memory 52, and sequentially executes the processes included in the determination program 260. The CPU 51 executes the communication process 62, thereby operating as the communication unit 18 illustrated in FIG. 8. The CPU 51 executes the control process 63, thereby operating as the controller 20 illustrated in FIG. 8. The CPU 51 executes the user operation detection process 65, thereby operating as the user operation detector 24 illustrated in FIG. 8. The CPU 51 executes the terminal orientation detection process 66, thereby operating as the terminal orientation detector 26 illustrated in FIG. 8. The CPU 51 executes the terminal momentum detection process 267, thereby operating as the terminal momentum detector 227 illustrated in FIG. 8. The CPU 51 executes the touch state analysis process 67, thereby operating as the touch state analyzer 28 illustrated in FIG. 8. The CPU 51 executes the degree-of-interest calculation process 68, thereby operating as the degree-of-interest calculator 230 illustrated in FIG. 8. The CPU 51 executes the careful watching change calculation process 69, thereby operating as the careful watching change calculator 32 illustrated in FIG. 8. The CPU 51 executes the psychology estimation process 70, thereby operating as the psychology estimator 34 illustrated in FIG. 8. Thus, the computer 250 executes the determination program 260, thereby functioning as the information processing terminal 216. The CPU 51 that executes the program is hardware.

The functions achieved by the determination program 260 may be achieved by a semiconductor integrated circuit, more specifically, an ASIC or the like, for example.

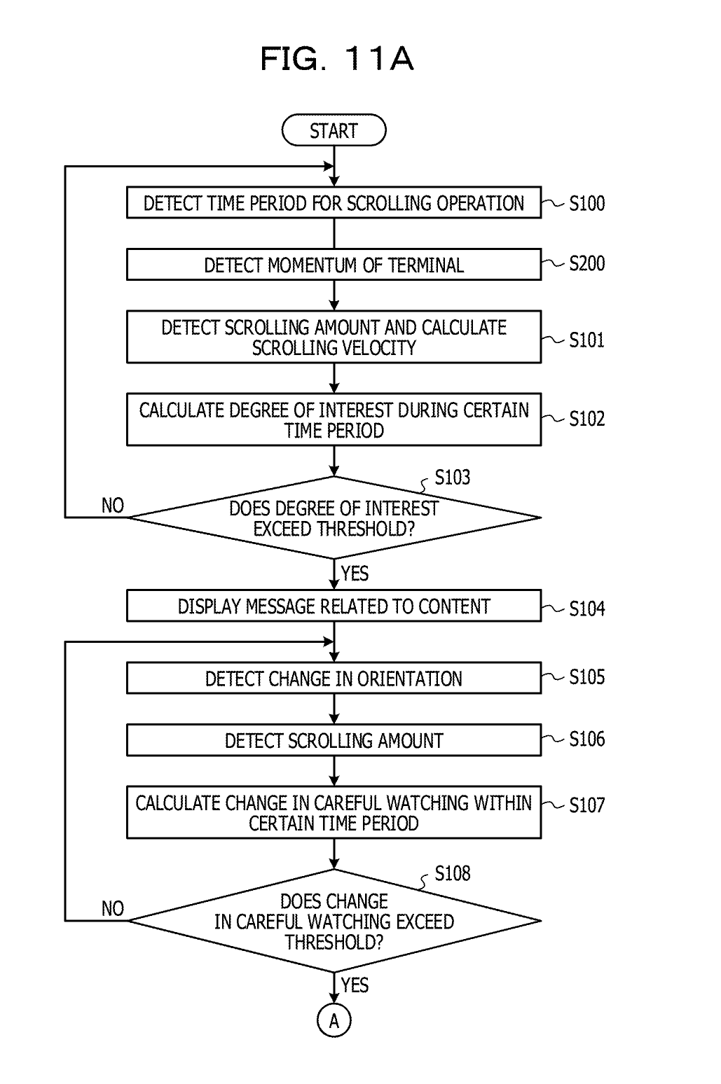

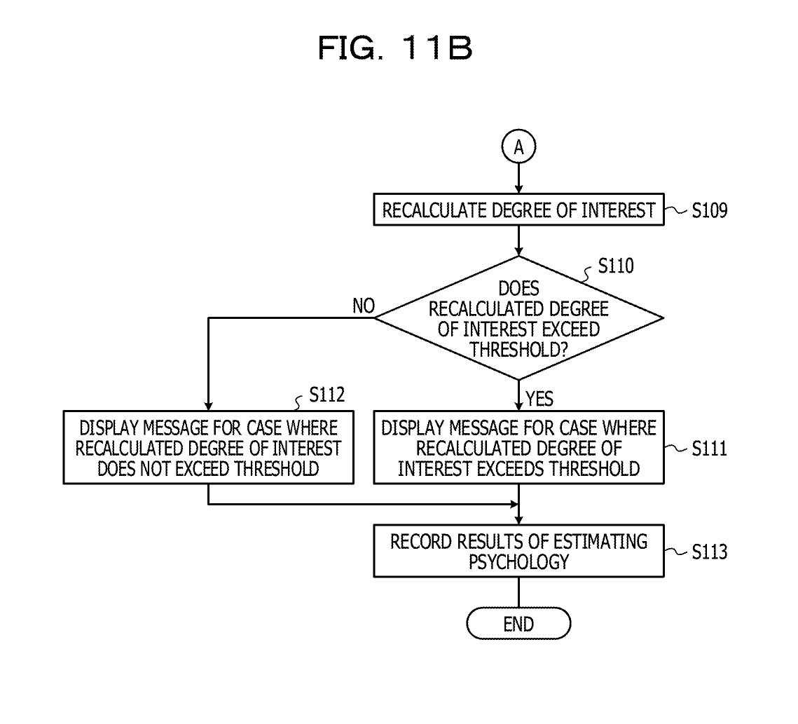

Effects of the determination system 210 according to the second embodiment are described below with reference to FIGS. 11A and 11B. In step S200, the terminal momentum detector 227 detects the momentum of the information processing terminal 216 for each of unit time periods. In S102, the degree-of-interest calculator 230 calculates a degree of interest according to the aforementioned Equation (3), for example. The other effects are the same as or similar to those described in the first embodiment, and a description thereof is omitted.

### Third Embodiment

Next, a third embodiment is described. Sections that are the same as those described in the second embodiment are indicated by the same reference symbols as those described in the second embodiment, and a description thereof is omitted.

The third embodiment is different from the second embodiment in that an enlargement rate of a screen displayed in an information processing terminal is used for the calculation of a degree of interest.

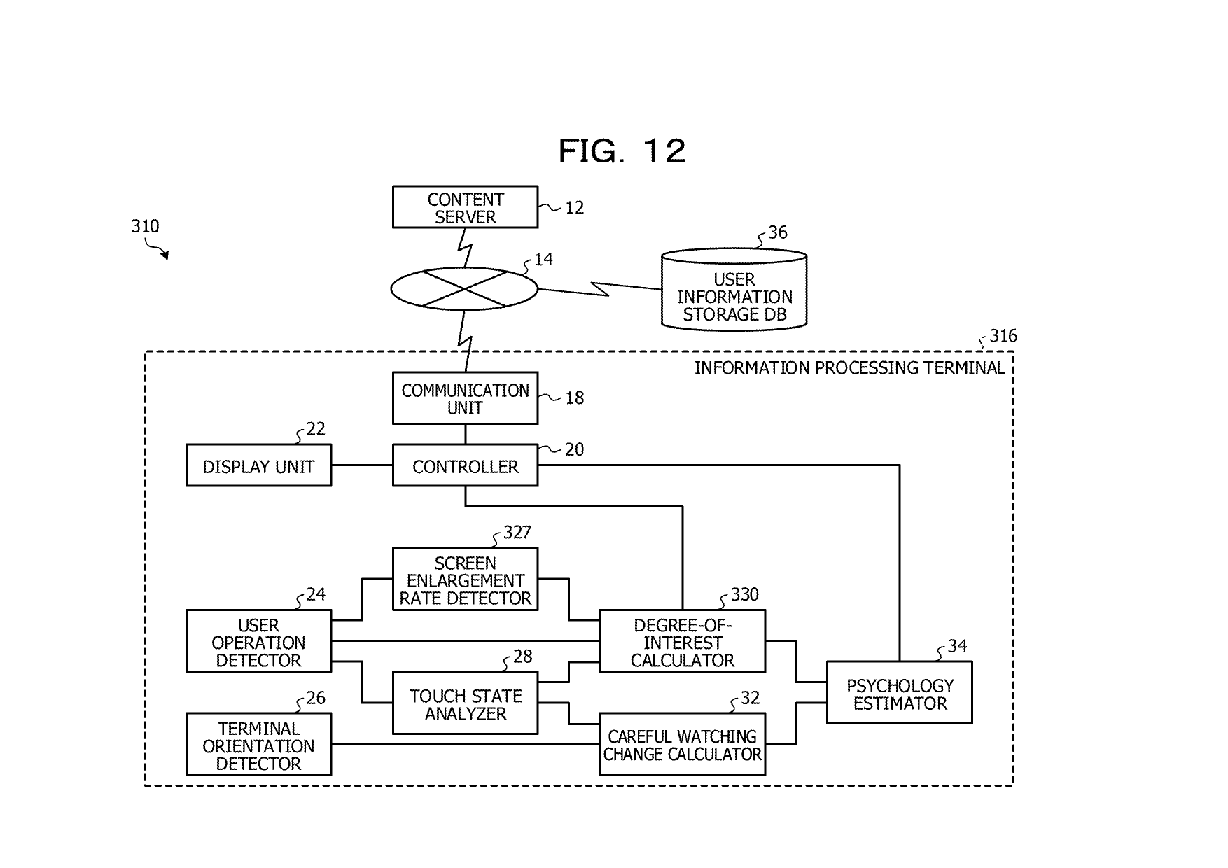

A determination system 310 according to the third embodiment is illustrated in FIG. 12 and includes the content server 12, an information processing terminal 316, and the user information storage DB 36. The content server 12, the information processing terminal 316, and the user information storage DB 36 are connected to each other via the network 14 such as the Internet.

The information processing terminal 316 includes the communication unit 18, the controller 20, the display unit 22, the user operation detector 24, the terminal orientation detector 26, a screen enlargement rate detector 327, a degree-of-interest calculator 330, the careful watching change calculator 32, and the psychology estimator 34.

The screen enlargement rate detector 327 detects a screen enlargement rate that is an example of an operational state of the information processing terminal 316. The screen enlargement rate is detected based on operations of zooming out and in the screen by pinch-in and pinch-out among input operations detected by the user operation detector 24. The screen enlargement rate detector 327 detects a zoom operation time length for operations of enlarging and reducing the screen by pinch-out and pinch-in.

The degree-of-interest calculator 330 calculates a degree of interest for each of unit time periods included in a certain unit time period. The degree of interest is calculated based on a time length for a scrolling operation in a user operation detected by the user operation detector 24, a nonoperation time length detected by the user operation detector 24, a scrolling velocity detected by the touch state analyzer 28, the screen enlargement rate detected by the screen enlargement rate detector 327, and a zoom operation time length detected by the screen enlargement rate detector 327. The degree of interest is calculated according to the following Equation (4), for example.

$$I ( t ) = Σ a zoom operation time period + Σ \frac{a time period for a scrolling operation}{the scrolling velocity weight coefficient {w}_{scr}} * an enlargement rate coefficient {z}_{scr} + Σ a nonoperation time period * an enlargement rate coefficient {z}_{nop} \qquad Equation ( 4 )$$

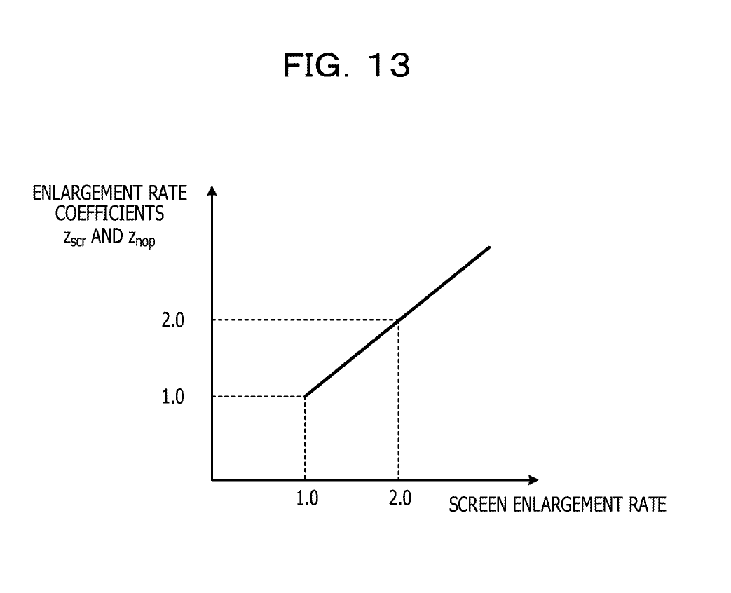

In the third embodiment, a degree I(t) of interest in a content is calculated for each of unit time periods (of 1 second as an example). In the aforementioned Equation (4), a method for setting the scrolling velocity weight coefficient W_{scr} is the same as or similar to that described in the first embodiment. As screen enlargement rate weight coefficients, the enlargement rate coefficient z_{scr} and the enlargement rate coefficient zₙₒₚ are set. The enlargement rate coefficient z_{scr} is a weight coefficient related to the screen enlargement rate for an operation time length. The enlargement rate coefficient z_{scr} is a weight coefficient related to the screen enlargement rate for a nonoperation time length. As illustrated in FIG. 13, for example, the enlargement rate coefficients z_{scr} and zₙₒₚ are set on the assumption that weights when the screen enlargement rate is 2.0 are 1.0 and that as the enlargement rate is larger, a degree of user's interest in a content is larger and the enlargement rate coefficients z_{scr} and zₙₒₚ linearly increase. In the example illustrated in FIG. 13, the enlargement rate coefficients z_{scr} and zₙₒₚ increase by 1 in a stepwise manner based on a multiple of the screen enlargement rate so that, when the screen enlargement rate increases to 2.0, the enlargement rate coefficients z_{scr} and zₙₒₚ increase to 2.0. In the third embodiment, the rates of increasing the enlargement rate coefficients z_{scr} and zₙₒₚ are equal to each other. However, for example, the rate of increasing the enlargement rate coefficient zₙₒₚ may be set to 1.2 on the assumption that a degree of interest is high during a nonoperation time.

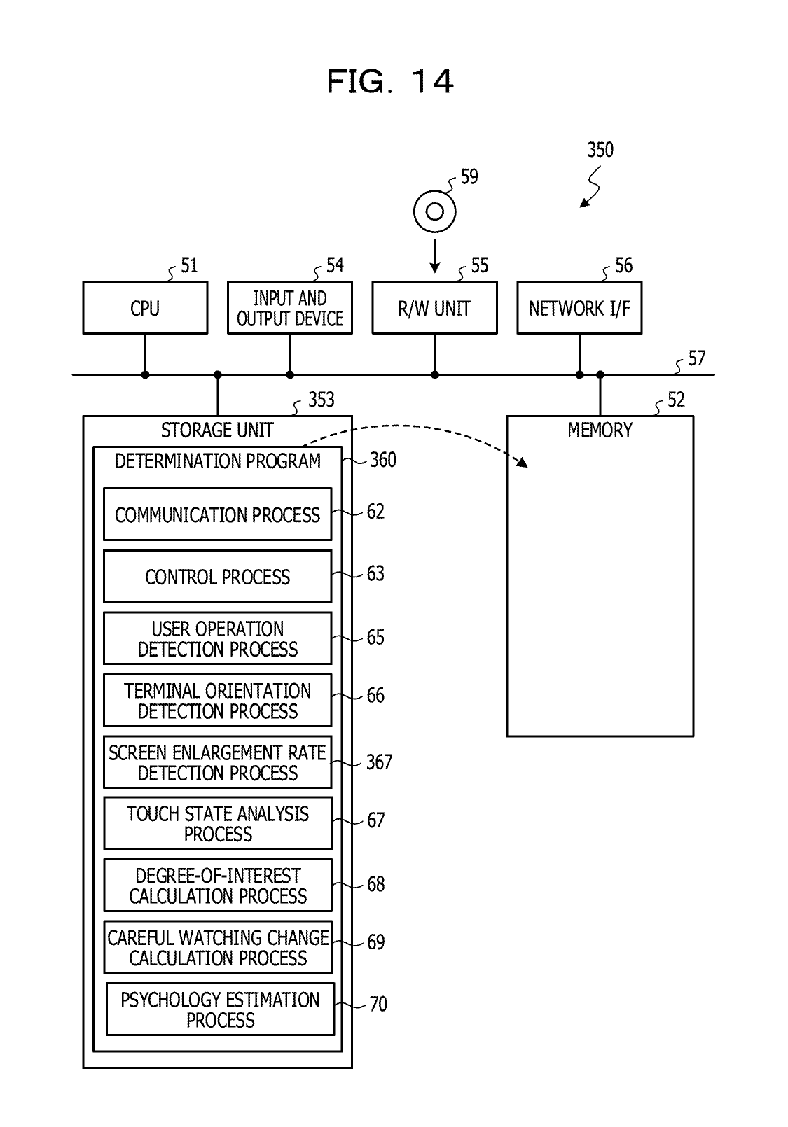

The information processing terminal 316 may be achieved by a computer 350 illustrated in FIG. 14, for example. The computer 350 includes the CPU 51, the memory 52 serving as the temporal storage region, and a nonvolatile storage unit 353. The computer 350 also includes the input and output device 54 serving as the display unit 22, the touch panel superimposed on the display unit 22, and the like, and the (R/W) unit 55 that controls reading and writing of data from and to the recording medium 59. The computer 350 also includes the network I/F 56 that is connected to a network such as the Internet. The CPU 51, the memory 52, the storage unit 353, the input and output device 54, the R/W unit 55, and the network I/F 56 are connected to each other via the bus 57.

The storage unit 353 may be achieved by an HDD, an SSD, a flash memory, or the like. In the storage unit 353 serving as a storage medium, a determination program 360 that causes the computer 350 to function as the information processing terminal 316 is stored. The determination program 360 includes the communication process 62, the control process 63, the user operation detection process 65, the terminal orientation detection process 66, and a screen enlargement rate detection process 367. The determination program 360 also includes the touch state analysis process 67, the degree-of-interest calculation process 68, the careful watching change calculation process 69, and the psychology estimation process 70.

The CPU 51 reads the determination program 360 from the storage unit 353, loads the read determination program 360 into the memory 52, and sequentially executes the processes included in the determination program 360. The CPU 51 executes the communication process 62, thereby operating as the communication unit 18 illustrated in FIG. 12. The CPU 51 executes the control process 63, thereby operating as the controller 20 illustrated in FIG. 12. The CPU 51 executes the user operation detection process 65, thereby operating as the user operation detector 24 illustrated in FIG. 12. The CPU 51 executes the terminal orientation detection process 66, thereby operating as the terminal orientation detector 26 illustrated in FIG. 12. The CPU 51 executes the screen enlargement rate detection process 367, thereby operating as the screen enlargement rate detector 327 illustrated in FIG. 12. The CPU 51 executes the touch state analysis process 67, thereby operating as the touch state analyzer 28 illustrated in FIG. 12. The CPU 51 executes the degree-of-interest calculation process 68, thereby operating as the degree-of-interest calculator 330 illustrated in FIG. 12. The CPU 51 executes the careful watching change calculation process 69, thereby operating as the careful watching change calculator 32 illustrated in FIG. 12. The CPU 51 executes the psychology estimation process 70, thereby operating as the psychology estimator 34 illustrated in FIG. 12. Thus, the computer 350 executes the determination program 360, thereby functioning as the information processing terminal 316. The CPU 51 that executes the program is hardware.

The functions achieved by the determination program 360 may be achieved by a semiconductor integrated circuit, more specifically, an ASIC or the like, for example.

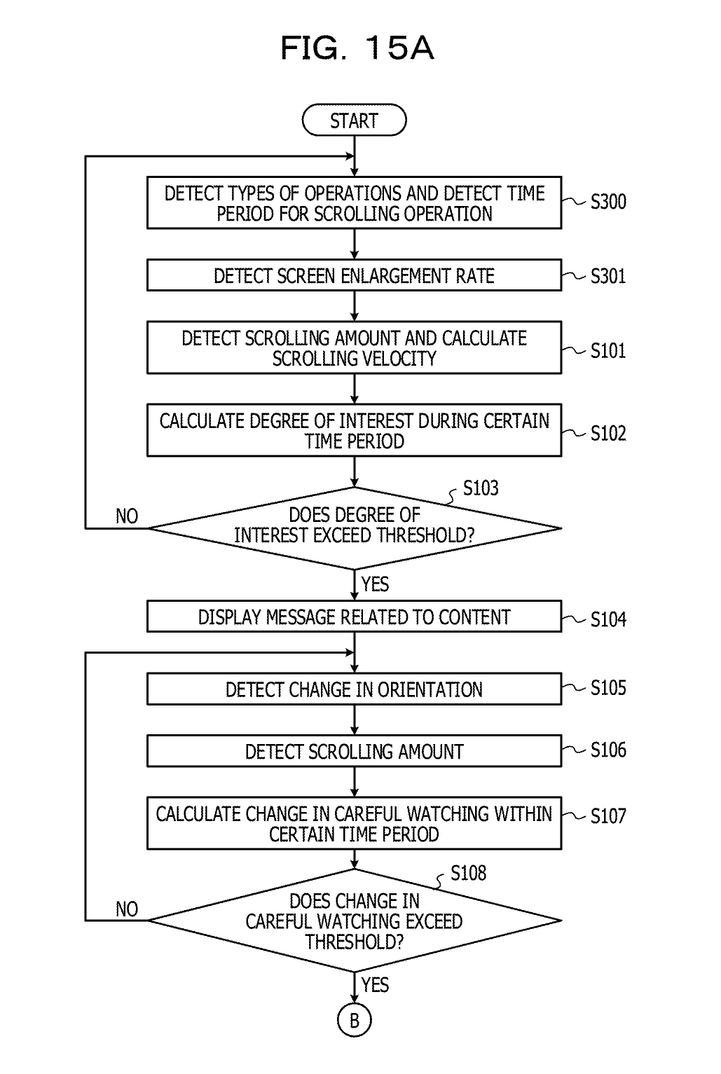

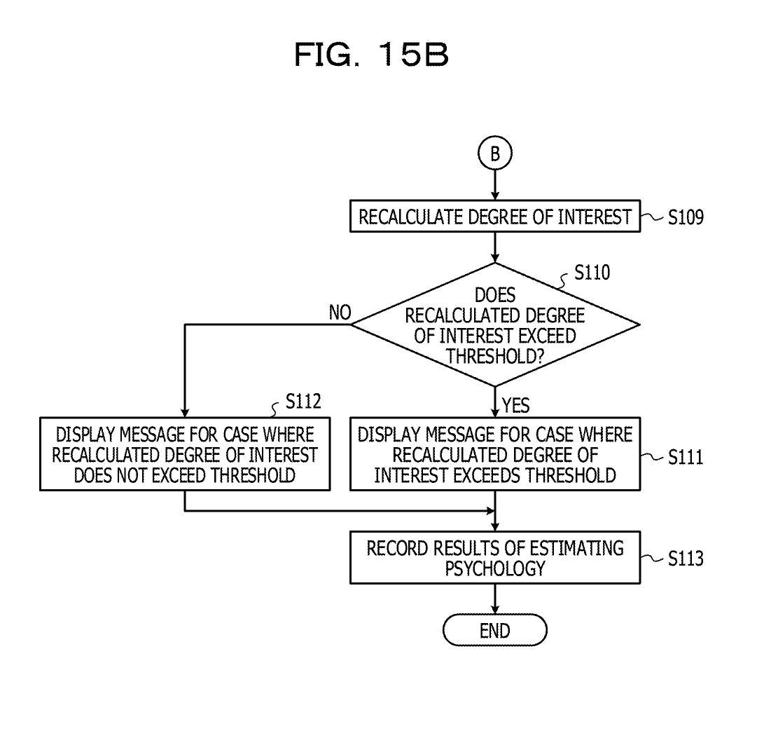

Effects of the determination system 310 according to the third embodiment are described below with reference to FIGS. 15A and 15B. In step S300, the user operation detector 24 detects the types of input operations such as tapping, flicking, swiping, and pinching and detects a time length for a scrolling operation by the user for each of unit time periods included in a certain time period (of 30 seconds in this example). In step S301, the screen enlargement rate detector 327 detects the screen enlargement rate of the information processing terminal 316 based on an operation of zooming out and in the screen by pinch-in and pinch out among the types of the operations detected in step S300. In step S102, the degree-of-interest calculator 330 calculates a degree of interest according to the aforementioned Equation (4), for example. The other effects are the same as or similar to those described in the first embodiment, and a description thereof is omitted.

Next, a modified example of each of the embodiments is described.

The embodiments describe the cases where each of the information processing terminals includes the touch state analyzer, the degree-of-interest calculator, the careful watching change calculator, and the psychology estimator, but the embodiments are not limited to this. For example, each of the determination systems may include a user information managing server that includes the touch state analyzer, the degree-of-interest calculator, the careful watching change calculator, and the psychology estimator. In this case, a user's input operation detected by each of the information processing terminals and a change in the orientation of each of the information processing terminals are transmitted to the user information managing server via the network, and the user information managing server calculates a degree of interest and calculates a change in careful watching. The user information managing server instructs each of the information processing terminals to present a message via the network based on the degree of interest that has been calculated by the user information managing server and the change in the careful watching that has been calculated by the user information managing server.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a processor of a terminal device to execute a process, the process comprising:
detecting at least one of information on an operational state of the terminal device and information on the orientation of the terminal device; and
when predetermined information is displayed on a screen of the terminal device, calculating a change in careful watching of the screen by an operator who operates the terminal device, based on at least one of the information on the operational state of the terminal device and the information on the orientation of the terminal device.

2. The storage medium according to claim 1,
wherein the predetermined information is first information,
wherein the process further comprises:
calculating a degree of interest in information displayed on the screen based on information on an operation performed on the screen;
displaying the first information on the screen based on the calculated degree of interest; and
displaying second information on the screen based on the calculated change in the careful watching.

3. The storage medium according to claim 1, wherein the process further comprises
calculating a change in the careful watching based on the information on the orientation of the terminal device when an operation is not performed on the terminal device.

4. The storage medium according to claim 1, wherein the process further comprises
calculating a change in the careful watching based on information on a change in the screen as the operational state of the terminal device when an operation is performed on the terminal device.

5. The storage medium according to claim 1, wherein the calculating the change in the careful watching includes
calculating the change in the careful watching based on the weighted linear sum for a first change amount, calculated based on the information on the orientation of the terminal device when an operation is not performed on the terminal device, of the careful watching and a linear weight for a second change amount, calculated based on information on a change in the screen as the operational state of the terminal device when an operation is performed on the terminal device, of the careful watching.

6. The storage medium according to claim 1,
wherein the calculating the change in the careful watching includes calculating a change in careful watching of each of users, and
wherein the process further comprises recording results related to the changes in the careful watching of the users.

7. A terminal device comprising:
a display; and
a processor coupled to the display and configured to:
detect at least one of information on an operational state of the terminal device and information on the orientation of the terminal device, and
when predetermined information is displayed on a screen of the terminal device, calculate a change in careful watching of the screen by an operator who operates the terminal device, based on at least one of the information on the operational state of the terminal device and the information on the orientation of the terminal device.

8. The terminal device according to claim 7,
wherein the predetermined information is first information,
wherein the processor is configured to:
calculate a degree of interest in information displayed on the screen based on information on an operation performed on the screen,
display the first information on the screen based on the calculated degree of interest, and
display second information on the screen based on the calculated change in the careful watching.

9. The terminal device according to claim 7, wherein the processor is configured to
calculate a change in the careful watching based on the information on the orientation of the terminal device when an operation is not performed on the terminal device.

10. The terminal device according to claim 7, wherein the processor is configured to
calculate a change in the careful watching based on information on a change in the screen as the operational state of the terminal device when an operation is performed on the terminal device.

11. The terminal device according to claim 7, wherein the processor is configured to
calculate the change in the careful watching based on the weighted linear sum for a first change amount, calculated based on the information on the orientation of the terminal device when an operation is not performed on the terminal device, of the careful watching and a linear weight for a second change amount, calculated based on information on a change in the screen as the operational state of the terminal device when an operation is performed on the terminal device, of the careful watching.

12. The terminal device according to claim 7, wherein the processor is configured to:
calculate a change in careful watching of each of users, and
record results related to the changes in the careful watching of the users.

13. A determination method executed by a processor of a terminal device, the determination method comprising:
detecting at least one of information on an operational state of the terminal device and information on the orientation of the terminal device; and
when predetermined information is displayed on a screen of the terminal device, calculating a change in careful watching of the screen by an operator who operates the terminal device, based on at least one of the information on the operational state of the terminal device and the information on the orientation of the terminal device.
